(19) United States
(12) Patent Application Publication
(10) Pub. No.: US 2016/0279643 A1
(43) Pub. Date: Sep. 29, 2016

(54) METHOD FOR FRAGMENTING AND/OR PRE-WEAKENING MATERIAL BY MEANS OF HIGH-VOLTAGE DISCHARGES

(71) Applicant: SELFRAG AG, Kerzers (CH)

(72) Inventors: Reinhard Müller-siebert, Bern (CH); Frédéric Von Der Weid, Genolier (CH)

(21) Appl. No.: 15/031,381

(22) PCT Filed: Oct. 25, 2013
(86) PCT No.: PCT/CH2013/000185

§ 371 Date: Apr. 22, 2016

(51) Int. Cl. B02C 19/18; B02C 25/00

(52) U.S. Cl. CPC B02C 19/18; B02C 25/00; B02C 2019/183

(57) ABSTRACT

The invention relates to a method for fragmenting material (1) by means of high-voltage discharges (6). The material (1) to be fragmented is guided through a process zone (5) formed between two electrodes (3, 4), while high-voltage discharges (6) are generated between said electrodes (3, 4) for fragmenting the material (1). The high-voltage discharges (6) are triggered subject to a continuously determined process parameter, which represents the situation with respect to the material (1) located in the process zone (5). In this way, the process can be guided such that high-voltage discharges (6) are only triggered if there is a situation in the process zone (5) in which a specified fragmentation work can be performed.

By this, the energy efficiency of the process can be considerably improved, and an excessive fragmentation of the material (1) can be prevented.

### TECHNICAL FIELD

The invention relates to methods for fragmenting and/or pre-weakening material by means of high-voltage discharges as well as an installation for carrying out the method according to the preambles of the independent claims.

### PRIOR ART

It is known from the prior art how to crush or pre-weaken material pieces, e.g. concrete or rock, by means of pulsed high-frequency discharges, i.e. to provide it with cracks in such a way that they can be crushed easier in a subsequent mechanical crushing process.

In order to be able to use this technology in the industry economically, it is crucial that a high energy efficiency of the fragmenting and/or pre-weakening process is reached and that it can be ensured also under varying operating conditions. This is still an unsolved problem, particularly in the field of treating minerals, because the material to be fragmented and/or pre-weakened in these applications is a natural product, the physical properties and composition of which may vary in wide areas.

### DESCRIPTION OF THE INVENTION

Hence, it is the objective of the invention to provide methods for fragmenting and/or pre-weakening material by means of high-voltage discharges which ensure a high energy efficiency of the fragmenting and/or pre-weakening process even in case of varying quality and/or quantity of the material to be fragmented and/or pre-weakened, respectively, or which at least reduce the influence of this variation on the energy efficiency of the fragmenting and/or pre-weakening process, respectively.

This objective is reached by the subject matters of the independent claims.

According to them, a first aspect of the invention relates to a method for fragmenting and/or pre-weakening material, preferably rock material or ore, by means of high-voltage discharges. The material to be fragmented and/or pre-weakened is guided through the process zone formed between at least two electrodes at a distance from one another, while high-voltage discharges are generated between these electrodes, by means of which the material is fragmented and/or pre-weakened. The high-voltage discharges are triggered individually or as a sequence of multiple high-voltage discharges, depending on one or more process parameters determined continuously, wherein the parameters represent a current and/or a future situation related to the material located in the process zone. In this way it is possible to carry out the process in such a way that high-voltage discharges are only triggered when a situation is present in the process zone, in which fragmentation and/or pre-weakening work, respectively, can be carried out as intended, e.g. because a sufficient material filling level is present in the process zone or e.g. because in the process zone there is material which is not yet fragmented to target size and/or is not sufficiently pre-weakened. Accordingly, the energetic degree of efficiency of the process can be substantially improved and an excessive fragmentation and/or pre-weakening of the material are avoided.

Preferably, the continuously determined process parameter(s) represents or represent at least the current or a future material filling level of the process zone, the current or a future piece size or piece size distribution of the material located in the process zone and/or a fragmenting degree or a pre-weakening degree, respectively, of the material located in the process zone. Process parameters representing these aspects of the situation with regard to the material located in the process zone are particularly suitable for controlling the triggering of the high-voltage discharges.

In a preferred embodiment of the method at least a parameter (process zone parameter according to the claims) is determined continuously for determining the process parameter or parameters, which represents a property of the content or of a part of the content of the process zone or of a neighboring region of the process zone. In this way the situation related to the material located in the process zone can be acquired practically without delay.

The following parameters are particularly preferred here:

the electric capacity, the electric conductivity or the permittivity of the content of the process zone or of a part of the content of the process zone or of a neighboring region of the process zone,

the material filling weight or the material filling level of the process zone or of the neighboring region of the process zone, as well as

the piece size or the piece size distribution of the material located in the process zone or in the neighboring region of the process zone.

In an alternative or supplementary preferred embodiment of the method, for which the material of the process zone to be fragmented and/or pre-weakened, respectively, is supplied continuously as material stream, at least a parameter (material supply parameter according to the claims) is determined, for determining the process parameter(s), which represents a property of the material stream in a region upstream of the process zone. In this way a future situation related to the material located in the process zone can be acquired.

The following parameters are particularly preferred here:

the electric capacity, the electric conductivity or the permittivity of the material stream in the region,

the volume flow or the mass flow of the material stream or of the material to be fragmented or pre-weakened transported by the material stream, respectively, in the region, as well as

the piece size or the piece size distribution of the material located in the region.

Preferably, in case of the above mentioned preferred embodiment of the method, for which the process parameter or parameters represent(s) a future situation with respect to the material located in the process zone, the instants in future, at which the situation represented by each process parameter in the process zone occurs, is determined by taking into account the supply speed of the material stream towards the process zone and the distance between the location of the determination of the material supply parameters. The high-voltage discharges are then triggered each at this instant depending on the corresponding process parameter. In this way the triggering, according to the situation, of the high-voltage discharges is possible by means of parameters determined far away from the process zone.

In a further preferred embodiment of the method the continuously determined process parameter or parameters is or are compared continuously with a threshold value and the high-voltage discharges or the sequences of high-voltage discharges are each triggered when the process parameter matches the threshold value or exceeds or falls below a certain value. Such a threshold value can be adapted in a simple way to different operating conditions, such that the method is universally applicable and can be integrated as part of a larger collective method.

It is therefore preferred that a threshold value is used, which is determined beforehand in such a way that a material situation is effected in the region where the respective parameter for determining the process parameter is determined, for which a desired criterion for triggering high-voltage discharges is fulfilled, wherein thereafter the process parameter is determined in this state and this process parameter is used as threshold value in the method according to the invention. In this way it is possible to adapt the method in a simple way to different materials and prescriptions related to the fragmenting or pre-weakening result, respectively.

In a preferred sub-variant of this embodiment of the method a single material piece with a size for which the triggering of high-voltage discharges is desired, or a certain material quantity, for which the triggering of high-voltage discharges is desired, is arranged in the process zone. Subsequently the process parameter is determined, which represents a property of the content or of a part of the content of the process zone, or of a region neighboring the process zone. This process parameter is then used as threshold value in the method according to the invention.

In a further preferred sub-variant of this embodiment a single material piece is arranged in a region upstream of the process zone, with a size which shall lead to a triggering of high-voltage discharges when it is present in the process zone, or a certain material quantity which shall lead to a triggering of high-voltage discharges when it is present in the process zone. Subsequently the process parameter is determined, which represents a property of the material piece or of the material quantity in the region upstream of the process zone. This process parameter is used as threshold value in the method according to the invention.

In a further preferred variant it is also provided that at least a parameter of a method preceding the method according to the invention, in which the material for fragmenting or for pre-weakening, respectively, is pre-treated and/or of a method following the method according to the invention, in which the material for fragmenting or for pre-weakening, is post-treated, is determined and the threshold value is changed based on this parameter.

Preferably, the preceding method and/or the subsequent method is a method for fragmenting and/or pre-weakening material by means of high-voltage discharges, preferably also a method according to the invention.

Advantageously, a parameter of a preceding method is determined, representing properties of the material emerging from the preceding method, which shall be fragmented or pre-weakened, respectively, in the method according to the invention, particularly the material type, the material quantity, the fragmentability, the material hardness and/or the piece size of this material.

The following parameters are particularly preferred here:

the energy consumption of a device for treating the material in the preceding method, preferably a crusher or a mill,

the piece size of the material emerging from the preceding method,

the consumption of chemical materials used in the preceding method,

the concentration of certain materials in a process liquid of the preceding method, as well as

the quantity of material which emerges from the preceding method.

Alternatively or supplementary, it is advantageous that a parameter of a subsequent method is determined, which represents properties of the fragmented or pre-weakened material, respectively, after it has emerged from the method according to the invention and which is supplied to the subsequent method, preferably the material type, the material quantity, the fragmentability, the material hardness and/or the piece size of this material.

The following parameters are particularly preferred here:

the energy consumption of a device for treating the material in the subsequent method, particularly a crusher or a mill,

the pressure of a ball mill cyclone used in the subsequent method, the piece size of the material supplied to the subsequent method,

the consumption of chemical materials used in the subsequent method,

the concentration of certain materials in a process liquid of the subsequent method,

the rejection rate or a recovery rate reached in the subsequent method, as well as

the quantity of material which emerges from the subsequent method.

In yet another preferred embodiment of the invention the process zone is flooded with a process liquid, particularly with water, during the triggering of high-voltage discharges, wherein it is further preferred that process liquid passes through the process zone. In this way fine particles can be removed from the process zone and stable operating conditions can be ensured.

Preferably, the method according to the invention is used for fragmenting and/or pre-weakening precious metal ore or a semi-precious metal ore, particularly copper ore or copper/gold ore or platinum ore.

In yet another preferred embodiment of the method a fragmenting and/or a pre-weakening of the material to be fragmented and/or pre-weakened is carried out before the method, preferably fragmenting and/or pre-weakening by high-voltage discharges, which is preferably also carried out by executing the method according to the invention.

In yet another preferred embodiment of the method a fragmenting and/or a pre-weakening of the material fragmented and/or pre-weakened emerging from the method is carried out after the method, preferably a fragmenting and/or weakening by means of high-voltage discharges, which is preferably also carried out by executing the method according to the invention, or a mechanical fragmenting.

A second aspect of the invention relates to an installation for usage in the method according to the first aspect of the invention. The installation comprises a process zone formed between at least two electrodes arranged at a distance from one another, means for guiding the material to fragment or to pre-weaken, respectively, through the process zone, as well as means for generating high-voltage discharges between the at least two electrodes during the guiding of the material to fragment or to pre-weaken, respectively, through the process zone, for fragmenting and/or pre-weakening the material (1), respectively. The means for guiding the material to fragment or to pre-weaken, respectively, through the process zone, may comprise e.g. a conveying band, a vibration conveyor or an oblique surface serving as slide. The means for generating high-voltage discharges between the at least two electrodes comprise typically a high-voltage generator and lines to the electrodes, and are formed in such a way according to the invention that a targeted triggering of single high-voltage discharges or of single sequences of multiple high-voltage discharges is possible.

In a preferred embodiment the installation according to the invention further has means for continuously determining at least a process parameter representing the current or a future situation related to the material located in the process zone, preferably for continuously determining of at least a process parameter representing the current or a future material filling level of the process zone, the current or a future piece size or piece size distribution of the material located in the process zone and/or a fragmenting degree or a pre-weakening degree, respectively, of the material located currently or in future in the process zone. The means for continuously determining at least a process parameter comprise typically measurement arrangements for determining certain physical variables in certain areas of the installation. The installation also has in this embodiment an installation controller by means of which the single high-voltage discharges or sequences of multiple high-voltage discharges can each be triggered depending on the respective determined process parameters. Such an installation is particularly suitable for carrying out the method according to the first aspect of the invention in an automatized way.

Here it is preferred that the means for continuously determining the at least one process parameter are formed in such a way that they can determine at least a parameter (process zone parameter according to the claims) which represents a property of the content or of a part of the content of the process zone, respectively, or of a neighboring region of the process zone.

The following parameters are particularly preferred here:

the electric capacity, the electric conductivity or the permittivity of the content or of a part of the content, respectively, of the process zone or of a neighboring region of the process zone,

the material filling weight and/or the material filling level of the process zone or of a neighboring region of the process zone, as well as

the piece size or the piece size distribution of the material located in the process zone or in a neighboring region of the process zone.

It is also preferred that the installation additionally has means for continuously supplying the material to be fragmented and/or pre-weakened, respectively, as material stream to the process zone and that the means for continuously determining the process parameter are formed in such a way that they can determine at least a parameter (material supplying parameter according to the claims) of the material stream in a region upstream of the process zone for determining the process parameter.

The following parameters are particularly preferred here:

the electric capacity, the electric conductivity and/or the permittivity of the material stream in the region,

the volume flow or the mass flow of the material stream or of the material to be fragmented and/or pre-weakened, respectively, transported by the material stream, as well as

the piece size or the piece size distribution of the material located in the region.

In the latter case it is furthermore preferred that the means for determining the at least one process parameter are formed in such a way that the process parameters determined by them represents each a future situation with respect to the material located in the process zone, and that the installation controller is formed in such a way that it can determine the instant in the future at which the situation represented by the respective process parameter in the process zone occurs, by taking into account the supply speed of the material stream towards the process zone and the distance between the location of the determination of the parameter (material supply parameter according to the claims), and the triggering of the high-voltage discharges or of the sequences of multiple high-voltage discharges by taking into account this instant can be carried out. In this way it is possible to control the triggering of the high-voltage discharges by means of parameters determined outside the process zone.

In a further preferred embodiment of the installation the installation controller is adapted to continuously compare the continuously determined process parameter with a threshold value and to trigger the high-voltage discharges or sequences of high-voltage discharges when the respective process parameter matches the threshold value or exceeds or falls below a certain value, respectively.

Here it is further advantageous that the installation controller is adapted to compare the process parameter with a threshold value which was previously determined by it by the means for continuously determining the process parameter, preferably automatically, by operating the installation in such a way that a material situation is caused in the region where the parameter or the parameters for determining the process parameter are determined, for which the triggering of high-voltage discharges is desired, wherein thereafter the process parameter is determined in this state and this process parameter is used as threshold value by the installation controller.

Here it is further preferred that the installation controller is adapted to previously determine the threshold value in such a way, preferably automatically, that the installation is operated in such a way that a single material piece or a certain material quantity is arranged in the process zone, for which the triggering of high-voltage discharges is desired, wherein subsequently the process parameter is determined by determining the process zone parameter which represents a property of the content or of the part of the content, respectively, of the process zone or of a neighboring region of the process zone, and wherein this process parameter is subsequently used by the installation controller as threshold value.

In case of installations having means for continuously supplying the material to be fragmented or pre-weakened, respectively, as material stream to the process zone, it is alternatively or supplementary preferred that the installation controller is adapted to previously determine the threshold value in such a way, particularly automatically, that the installation is operated in such a manner that a single material piece or a certain material quantity is arranged in a region upstream of the process zone, which correspond(s) to a single material piece, for which the triggering of high-voltage discharges is desired, when it is present in the process zone, that subsequently the process parameter which represents a property of the material piece or of the material quantity in the region upstream of the process zone, is determined and that this process parameter is subsequently used by the installation controller as threshold value.

It is also furthermore preferred in case of installations according to the invention with an installation controller, which are adapted to compare the continuously determined process parameter continuously with a threshold value, that the installation controller is formed in such a way that it can change the threshold value depending on one or more parameters of an installation upstream of the installation according to the invention and/or of an installation downstream of the installation according to the invention.

### SHORT DESCRIPTION OF THE DRAWINGS

Further embodiments, advantages and applications of the invention result from the dependent claims and from the now following description by means of the drawings. It is shown in:

FIGS. 1a to 1c strongly schematized a first method according to the invention;

FIG. 2 strongly schematized a second method according to the invention;

FIGS. 3a and 3b strongly schematized a third method according to the invention;

FIGS. 4a and 4b strongly schematized a fourth method according to the invention;

FIGS. 5a and 5b strongly schematized a fifth method according to the invention;

### WAYS FOR CARRYING OUT THE INVENTION

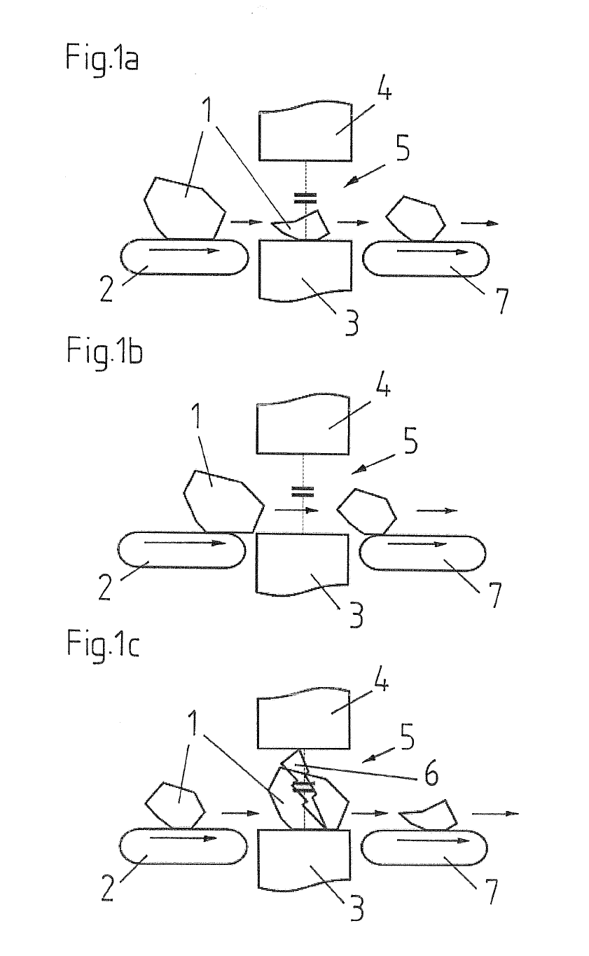

FIGS. 1a to 1c illustrate in a strongly schematized way a first method according to the invention for fragmenting and/or pre-weakening rock material by means of high-voltage discharges. As can be noticed, rock material 1 is guided to a process zone 5 formed between the two electrodes 3, 4 by means of a conveying band 2, where it can be fragmented by means of high-voltage discharges 6 generated between the two electrodes 3, 4, and it is subsequently guided away from the process zone 5 by means of a further conveying band 7. As indicated by the capacitor symbol, the electric capacity between the two electrodes 3, 4, i.e. of the content of the process zone 5 is determined, which varies depending on material piece size and which thereby represents the material piece size. The determined capacities are continuously compared to a threshold value, by means of which it is decided if a high-voltage discharge 6 fragmenting the material piece 1 shall be executed or not.

In the situation shown in FIG. 1a the material piece 1 with a piece size smaller than or equal to the target size is located in the process zone 5, such that a capacity results which is greater than the threshold value. In this case no high-voltage discharge is triggered and the material piece is guided through the process zone 5 without further fragmentation.

In the situation shown in FIG. 1b no material piece is located in the process zone 5, such that an even higher capacity than in the situation shown in FIG. 1a results. Accordingly, also in this case no high-voltage discharge is triggered.

In the situation shown in FIG. 1c a material piece 1 with a piece size greater than the target size is located in the process zone 5, such that a capacity results which is smaller than the threshold value. In this case a high-voltage discharge 6 is triggered and the material piece is fragmented in this way.

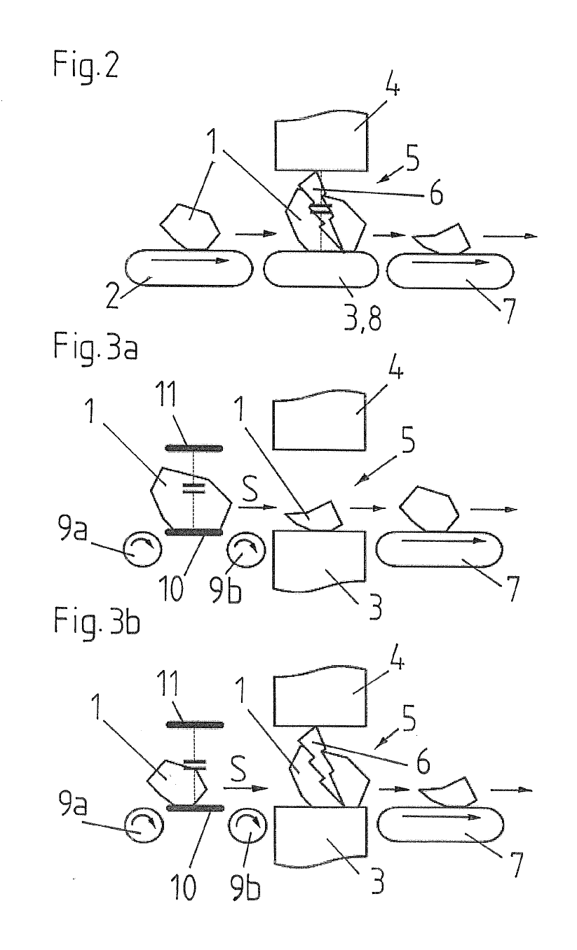

FIG. 2 shows strongly schematized a situation like in FIG. 1c in a second method according to the invention for fragmenting rock material by means of high-voltage discharges, which differs from the method illustrated in FIGS. 1a to 1c only in that the bottom electrode 3 is formed as metallic conveying band 8.

In FIGS. 3a and 3b a third method according to the invention for fragmenting rock material by means of high-voltage discharges is illustrated. As can be noticed rock material 1 is guided between two measurement electrodes 10, 11 arranged upstream of the process zone 5, by means of a transport device 9a, subsequently it is supplied to the process zone 5 where it can be fragmented by means of high-voltage discharges 6 generated between the two electrodes 3, 4, and it is subsequently guided away from the process zone 5 by means of a conveying band 7. As indicated by the capacitor symbol, the electric capacity between the two measurement electrodes 10, 11, which varies depending on material piece size 1 located between the electrodes 10, 11 and which thereby represents the material piece size, is continuously determined. The determined capacities are continuously compared to a threshold value by means of which it is decided if a high-voltage discharge 6 for fragmenting the material piece 1 shall be executed or not in the instant when the material piece 1 arrives in the process zone 5. The instant of arrival of the material piece 1 in the process zone 5 is determined from the supply speed S of the material piece 1 to the process zone 5 and the known distance between the measurement electrodes 10, 11 and the process zone 5.

In the situation shown in FIG. 3a a material piece 1 with a piece size greater than the target piece size is located between the two measurement electrodes 10, 11, such that a capacity is determined, which is smaller than the threshold value. In this case a high-voltage discharge 6 is triggered as soon as the material piece 1 has arrived in the process zone 5. This situation is shown in FIG. 3b. The subsequent material piece 1 just located between the measurement electrodes 10, 11 has a piece size smaller than or equal to the target size, such that a capacity is determined which is greater than the threshold value. In this case no high-voltage discharge is triggered as soon as this material piece 1 has arrived in the process zone 5 and the material piece is guided through the process zone 5 without further fragmentation.

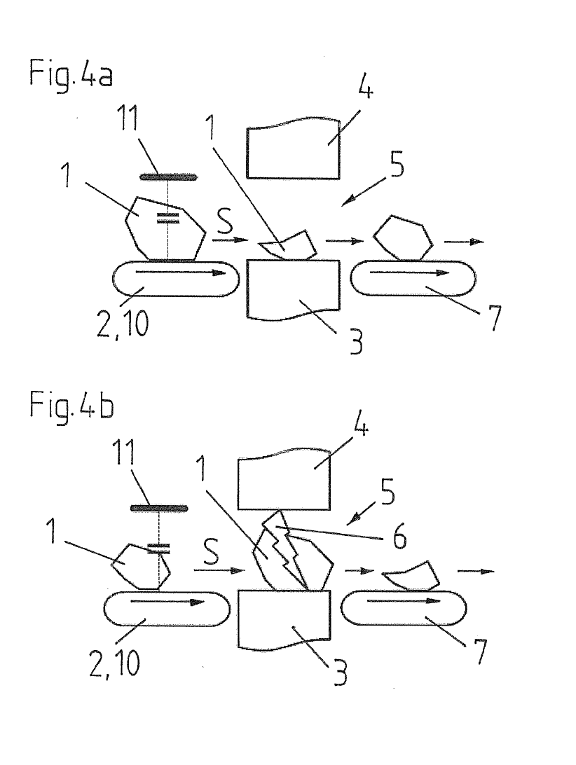

FIGS. 4a and 4b show strongly schematized a fourth method according to the invention for fragmenting rock material by means of high-voltage discharges. As can be noticed, this method differs from the method shown in FIGS. 3a and 3b only in that a conveying band 2 is used instead of the transport device 9a, 9b and of the bottom measurement electrode 10, which serves at the same time as bottom electrode 10.

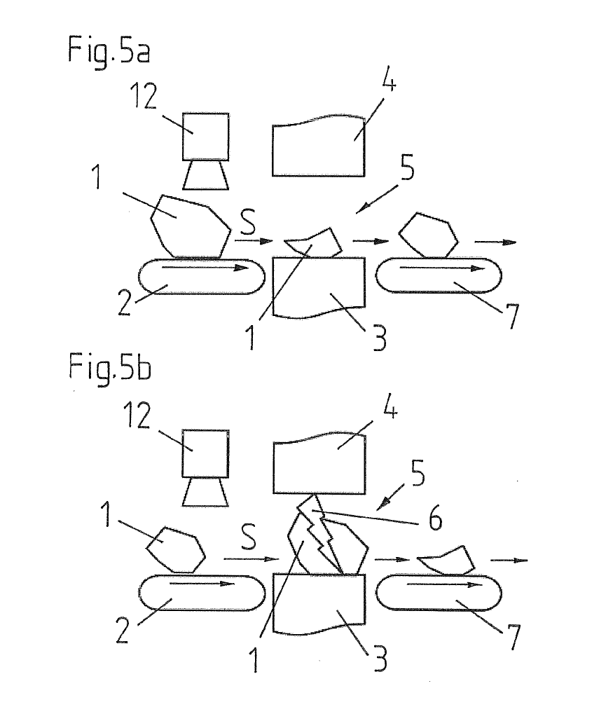

FIGS. 5a and 5b show strongly schematized a fifth method according to the invention for fragmenting rock material by means of high-voltage discharges. As can be noticed this method differs from the method shown in FIGS. 4a and 4b only in that a camera system 12 is used instead of the measurement electrodes, by means of which the piece size or the piece size distribution of the material in the region upstream of the process zone 5 is determined continuously. The determined piece sizes or piece size distributions are continuously compared with a threshold value by means of which it is determined if a high-voltage discharge 6 shall take place or not, for fragmenting the material piece 1, at the instant when the material piece 1 arrives in the process zone 5. The instant of arrival of the material piece 1 in the process zone 5 is determined based on the supply speed S of the material piece 1 to the process zone 5 and the known distance between the camera system 12 and the process zone 5.

In the situation shown in FIG. 5a a material piece 1 with a piece size greater than the target piece size is located in the view field of the camera system 12, such that a high-voltage discharge 6 is triggered as soon as the material piece 1 has arrived in the process zone 5, as shown in FIG. 5b.

While preferred embodiments of the invention are described in the present application, it has to be clearly stated that the invention is not limited thereto and may be executed in other ways within the scope of the now following claims.

1. A method for fragmenting and/or pre-weakening material, particularly rock material or ore, by means of high-voltage discharges, comprising:
a) providing a process zone between at least two electrodes at a distance from one another,
b) guiding the material to fragment or to pre-weaken, respectively, through the process zone, and
c) generating high-voltage discharges between the at least two electrodes during the guiding of the material to fragment or to pre-weaken, respectively, through the process zone, for fragmenting and/or pre-weakening the material, respectively,
wherein the high-voltage discharges are triggered, individually or as a sequence of multiple high-voltage discharges, depending on at least one process parameter determined continuously and representing the current and/or a future situation related to the material located in the process zone.

2. The method according to claim 1, wherein the process parameter represents the current or a future material filling level of the process zone.

3. The method according to claim 1, wherein the process parameter represents the current or a future piece size or piece size distribution of the material located in the process zone.

4. The method according to claim 1, wherein the process parameter represents a fragmenting degree or a pre-weakening degree, respectively, of the material located in the process zone.

5. The method according to claim 1, wherein at least a process zone parameter is determined continuously for determining the process parameter, which represents a property of the content or of a part of the content of the process zone or of a neighboring region of the process zone.

6. The method according to claim 5, wherein an electric capacity, an electric conductivity and/or a permittivity of the content or of a part of the content, respectively, of the process zone or of a neighboring region of the process zone is determined as process zone parameter.

7. The method according to claim 5, wherein a material filling weight and/or a material filling level of the process zone or of a neighboring region of the process zone is determined as process zone parameter.

8. The method according to claim 5, wherein a piece size or a piece size distribution of the material located in the process zone or in the neighboring region is determined as process zone parameter.

9. The method according to claim 1, wherein the material to be fragmented and/or pre-weakened, respectively, is supplied continuously to the process zone as material stream and wherein at least one material supply parameter is determined continuously for determining the process parameter, which represents a property of the material stream in a region upstream of the process zone.

10. The method according to claim 9, wherein an electric capacity, an electric conductivity and/or a permittivity of the material stream is determined in said as material supply parameter.

11. The method according to claim 9, wherein the volume flow and/or the mass flow of the material stream or of the material to be fragmented and/or pre-weakened, respectively, transported by the material stream is determined in said region as material supply parameter.

12. The method according to claim 9, wherein a piece size or a piece size distribution of the material located in said region is determined as material supply parameter.

13. The method according to claim 9, wherein the process parameter represents a future situation with respect to the material located in the process zone, and wherein the instant in future, at which the situation represented by the process parameter in the process zone occurs, is determined by taking into account the supply speed (S) of the material stream towards the process zone and the distance between the location of the determination of the material supply parameter, and wherein the high-voltage discharges are triggered at this instant depending on the process parameter.

14. The method according to one claim 5, wherein the at least one process parameter corresponds to the at least one process zone parameter and/or to the at least one material supply parameter.

15. The method according to claim 1, wherein the continuously determined process parameter is compared continuously with a threshold value and the high-voltage discharges or the sequence of high-voltage discharges are each triggered when the process parameter matches the threshold value or exceeds or falls below a certain value.

16. The method according to claim 15, wherein a threshold value is used, which is determined beforehand in such a way that a material situation is effected in the region where the process parameter or the process zone parameter determined for determining the process parameter, respectively, or the material supply parameter is determined, for which the triggering of high-voltage discharges is desired, wherein thereafter the process parameter is determined in this state and this process parameter is used as threshold value.

17. The method according to claim 16, wherein a threshold value is used, which is determined beforehand in such a way that a single material piece or a certain material quantity, for which the triggering of high-voltage discharges is desired, is arranged in the process zone, wherein subsequently the process parameter is determined by determining the process zone parameter which represents a property of the content or of a part of the content of the process zone, respectively, or of a neighboring region of the process zone, and wherein this process parameter is used as threshold value.

18. The method according to claim 16, wherein the material to be fragmented and/or pre-weakened, respectively, is supplied continuously to the process zone as material stream and wherein at least one material supply parameter is determined continuously for determining the process parameter, which represents a property of the material stream in a region upstream of the process zone, and wherein a threshold value is used, which is determined beforehand in such a way that a single material piece or a certain material quantity is arranged in a region upstream of the process zone, which correspond(s) to a material piece or a certain material quantity for which, when it is present in the process zone, the triggering of high-voltage discharges is desired, wherein subsequently the process parameter is determined by determining the material supply parameter which represents a property of the material piece or of the material quantity in the region upstream of the process zone, and wherein this process parameter is used as threshold value.

19. The method according to claim 15, wherein at least a parameter of a method preceding the method according to the invention and/or of a method following the method according to the invention is determined and the threshold value is changed based on this at least one parameter.

20. The method according to claim 19, wherein the preceding method and/or the subsequent method is a method for fragmenting and/or pre-weakening material by means of high-voltage discharges, particularly according to one of the preceding claims, for which the material supplied to the method according to the invention and/or the material emerging from the method according to the invention is fragmented and/or pre-weakened.

21. The method according to claim 19, wherein a parameter of a method preceding the method according to the invention is determined, representing properties of the material emerging from the preceding method, which is supplied to the process zone for fragmenting or pre-weakening it, respectively, particularly representing the material type, the material quantity, the fragmentability, the material hardness and/or the piece size of this material.

22. The method according to claim 21, wherein an energy consumption of a device for treating the material in the preceding method, particularly of a crusher or of a mill, the piece size of the material emerging from the preceding method, a consumption of chemical materials used in the preceding method, a concentration of certain materials in a process liquid of the preceding method and/or the quantity of material which emerges from the preceding method, is determined as parameter.

23. The method according to claim 19, wherein a parameter of a method following the method according to the invention is determined, which represents properties of the fragmented or pre-weakened material, respectively, which emerges from the method according to the invention and is supplied to the subsequent method, particularly representing the material type, the material quantity, the fragmentability, the material hardness and/or the piece size of this material.

24. The method according to claim 23, wherein the energy consumption of a device for treating the material in the subsequent method, particularly of a crusher or of a mill, the pressure of a ball mill cyclone used in the subsequent method, the piece size of the material supplied to the subsequent method, a consumption of chemical materials used in the subsequent method, a concentration of certain materials in a process liquid of the subsequent method, a rejection rate or a recovery rate reached in the subsequent method, and/or the quantity of material which emerges from the subsequent method, is determined as parameter.

25. The method according to claim 1, wherein the process zone is flooded with a process liquid during the triggering of high-voltage discharges, particularly with water.

26. The method according to claim 25, wherein process liquid passes through the process zone.

27. The method according to claim 1, wherein the material to be fragmented and/or pre-weakened, respectively, is a precious metal ore or a semi-precious metal ore, particularly copper ore or copper/gold ore or platinum ore.

28. The method according to claim 1, wherein a fragmenting and/or a pre-weakening of the material to be fragmented and/or pre-weakened is carried out before the method, particularly a fragmentation or a pre-weakening, respectively, by means of high-voltage discharges, particularly by carrying out the method according to one of the preceding claims.

29. The method according to claim 1, wherein a fragmenting and/or a pre-weakening of the material fragmented and/or pre-weakened by the method is carried out after the method, particularly a fragmentation and/or weakening by means of high-voltage discharges, particularly by carrying out the method according to one of the preceding claims, or a mechanical fragmentation.

30. An installation for usage with the method according to claim 1, the installation comprising:
a) a process zone between at least two electrodes at a distance from one another,
b) means for guiding the material to fragment or to pre-weaken, respectively, through the process zone, and
c) means for generating high-voltage discharges between the at least two electrodes during the guiding of the material to fragment or to pre-weaken, respectively, through the process zone, for fragmenting and/or pre-weakening the material,
wherein the means for generating high-voltage discharges between the at least two electrodes are formed in such a way that a targeted triggering of single high-voltage discharges or of single sequences of multiple high-voltage discharges is possible.

31. The installation according to claim 30, wherein the installation has means for continuously determining at least one process parameter representing the current and/or a future situation related to the material located in the process zone, particularly for continuously determining at least one process parameter representing the current or a future material filling level of the process zone or the current or a future piece size or piece size distribution of the material located in the process zone and/or a fragmenting degree or a pre-weakening degree, respectively, of the material located in the process zone, and wherein the installation has an installation controller by means of which the single high-voltage discharges or sequences of multiple high-voltage discharges can be triggered depending on the respective determined process parameter.

32. The installation according to claim 31, wherein the means for continuously determining the at least one process parameter are formed in such a way that they can determine at least one process zone parameter for determining the process parameter, which represents a property of the content or of a part of the content of the process zone or of a neighboring region of the process zone, particularly an electric capacity, an electric conductivity and/or a permittivity of the content or of a part of the content, respectively, of the process zone or of a neighboring region of the process zone, a material filling weight and/or a material filling level of the process zone or of the neighboring region of the process zone and/or a piece size or a piece size distribution of the material located in the process zone or in the neighboring region.

33. The installation according to claim 31, wherein the installation has means for continuously supplying the material to be fragmented and/or pre-weakened, respectively, as material stream to the process zone and wherein the means for continuously determining the process parameter are formed in such a way that they can determine at least one material supplying parameter of the material stream in a region upstream of the process zone for determining the process parameter, particularly an electric capacity, an electric conductivity and/or a permittivity of the material stream and/or the volume flow and/or the mass flow of the material stream or of the material to be fragmented and/or pre-weakened transported by the material stream and/or the piece size or the piece size distribution of the material located in the region.

34. The installation according to claim 33, wherein the means for determining the at least one process parameter are formed in such a way that the process parameter determined by them represents a future situation with respect to the material located in the process zone, and wherein the installation controller is formed in such a way that it can determine the instant in the future at which the situation represented by the process parameter in the process zone occurs, by taking into account the supply speed (S) of the material stream towards the process zone and the distance between the location of the determination of the material supply parameter and the process zone, and wherein the high-voltage discharges or the sequences of multiple high-voltage discharges are triggered by taking into account this instant.

35. The installation according to claim 31, wherein the installation controller is adapted to continuously compare the continuously determined process parameter with a threshold value and to trigger the high-voltage discharges or the sequence of high-voltage discharges when the process parameter matches the threshold value or exceeds or falls below it by a certain value.

36. The installation according to claim 35, wherein the installation controller is adapted to compare the process parameter with a threshold value which was previously determined by it by the means for continuously determining the process parameter, particularly automatically, by operating the installation in such a way that a material situation is caused in the region where the process parameter or the process zone parameter or the material supply parameter determined for determining the process parameter, respectively, is determined, for which the triggering of high-voltage discharges is desired, wherein thereafter the process parameter is determined in this state and this process parameter is used as threshold value by the installation controller.

37. The installation according to claim 36, wherein the installation controller is adapted to compare the process parameter with a threshold value which was previously determined by it by the means for continuously determining the process parameter, particularly automatically, by operating the installation in such a way that a single material piece or a certain material quantity is arranged in the process zone, for which the triggering of high-voltage discharges is desired, wherein subsequently the process parameter is determined by determining the process zone parameter which represents a property of the content or of the part of the content, respectively, of the process zone or of a neighboring region of the process zone, and wherein this process parameter is subsequently used by the installation controller as threshold value.

38. The installation according to claim 33, wherein the installation controller is adapted to compare the process parameter with a threshold value which was previously determined by it by the means for continuously determining the process parameter, particularly automatically, by operating the installation in such a way that a single material piece or a certain material quantity is arranged in a region upstream of the process zone, which correspond(s) to a material piece or a certain material quantity for which, when it is present in the process zone, the triggering of high-voltage discharges is desired, wherein subsequently the process parameter is determined by determining the material supply parameter which represents a property of the material piece or of the material quantity in the region upstream of the process zone, and wherein this process parameter is subsequently used by the installation controller as threshold value.

39. The installation according to claim 35, wherein the installation controller is formed in such a way that it can change the threshold value depending on one or more parameters of an installation upstream of the installation according to the invention and/or of an installation downstream of the installation according to the invention.
